(19) United States
(12) Patent Application Publication
(10) Pub. No.: US 2009/0231760 A1
(43) Pub. Date: Sep. 17, 2009

(54) HEAD CLIP AND WORKING METHOD USING THE SAME

(75) Inventors: Yoji Kaneko, Higashine (JP); Akihiko Homma, Higashine (JP); Tsutomu Asanuma, Higashine (JP); Yoshinori Asagi, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/243,562

(22) Filed: Oct. 1, 2008

(30) Foreign Application Priority Data
Mar. 17, 2008 (JP) 2008-068478

(51) Int. Cl. G11B 5/48

(52) U.S. Cl. 360/240

(57) ABSTRACT

A head clip used in a task of assembly, inspection, and maintenance such as repair or cleaning of a device having a head attached to an actuator, and to a working method using the head clip. The heads are located at an extreme end of the actuator. The head clip includes first and second support units inserted into the actuator so as to support suspensions to which the heads are disposed. The first support units are in contact with adjacent suspensions and support them at a first position which is located nearer to the pivoting fulcrum than to the heads in the longitudinal direction of the actuator. The second support units regulate the adjacent suspensions at a second position located at the extreme end, and the heads are disposed between the first position and the second position on the longitudinal direction.

### BACKGROUND OF THE INVENTION

1. Field of the Invention

The embodiments discussed herein are directed to a head clip and a working method using the same, and more particularly to a head clip used in a task of assembly, inspection, and maintenance such as repair or cleaning of a device having a head, and to a working method using the head clip.

2. Description of the Related Art

A magnetic storage device includes a plurality of magnetic recording media and a plurality of heads for recording and reproducing information. A magnetic disc device has a plurality of magnetic discs coaxially disposed at predetermined intervals, and one head disposed at the extreme end of a head actuator to move across the recording surface of each magnetic disc. When a task of the assembly, inspection, and maintenance such as repair or cleaning of these devices is performed, a head clip is used, to prevent careless motion of the head actuator.

FIG. 1 is a perspective view showing an example of a conventional head clip. A head clip 1 shown in FIG. 1 has a positioning shaft 2, a head fixing arm 3, and a plurality of comb-shaped teeth 4.

FIGS. 2A, 2B and 3 are views explaining how the head clip is attached to an actuator. FIG. 2A is a side elevational view showing the head clip 1 attached to an actuator 11, and FIG. 2B is an upper surface view showing the actuator 11 before the head clip 1 is attached thereto. As shown in FIGS. 2A and 2B, the actuator 11 has an actuator block 12, a coil 13, a unit bearing 14, a head clip insertion hole 15, suspensions 16, and a head assembly 17. The actuator 11 has the plurality of the suspensions 16 and the head assembly 17 disposed thereto.

The head clip 1 is attached to the actuator 11 by inserting the shaft 2 into the hole 15 from the upper surface side of the actuator 11 and pivoting the head clip 1 about the shaft 2. FIG. 3 is a bottom view of the actuator 11 showing how the head clip 1 is attached thereto. When the head clip 1 is attached to the actuator 11, the comb-shaped teeth 4 are inserted between two adjacent suspensions 16 to prevent heads 18, which are disposed at the extreme ends of the suspensions 16 in the head assembly 17, from colliding with each other.

FIGS. 4 and 5 are views explaining how the heads can collide with each other by a shock and the like. In FIGS. 4 and 5, the heads 18 are attached to the extreme ends of flexures 19 disposed on the suspensions 16. The confronting surfaces of two adjacent heads 18 have an interval set to a very narrow dimension of, for example, about 1 mm when the head clip 1 is attached to the actuator 11.

FIG. 4 shows the case in which the suspensions 16 have relatively low rigidity. In this case, even when the head clip 1 is attached to the actuator 11 and a shock and the like is applied to the actuator 11 and/or the head clip 1 from the outside, the suspensions 16 are vibrated, and adjacent heads 18 may collide with each other because the suspensions 16 and the flexures 19 vibrate as shown by broken lines. The shock occurs from the outside when the heads 18 are rinsed by air blow and the like when, for example, the head clip 1 is attached to the actuator 11.

FIG. 5 shows the case in which the suspensions 16 have relatively high rigidity. In this case, even when the head clip 1 is attached to the actuator 11, and the suspensions 16 are vibrated, and in particular, when the flexures 19 are vibrated by shock and the like from the outside, the adjacent heads 18 may collide with each other.

An example of a jig used when an actuator assembly is transported is proposed by Japanese Patent Application Laid-Open No. 2005-174459).

Conventionally, adjacent heads 18 can collide with each other due to shock and the like from the outside, and can be broken even if the head clip 1 is attached to the actuator 11.

Accordingly, an object of a head clip and a working method using the same according to an embodiment is to provide a head clip that can prevent breakage of heads and a working method using the head clip.

### SUMMARY

In accordance with an aspect of embodiments, a head clip attached to an actuator having heads at an extreme end thereof opposite to a pivoting fulcrum, includes first and second support units inserted into the actuator so as to support suspensions to which the heads are disposed, wherein the first support units are in contact with adjacent suspensions and support them at a first position which is located nearer to the pivoting fulcrum than to the heads in the longitudinal direction of the actuator, the second support units regulate the adjacent suspensions at a second position located at the extreme end, and the heads are disposed between the first position and the second position on the longitudinal direction.

### BRIEF DESCRIPTION OF THE DRAWINGS

FIG. 1 is a perspective view showing an example of a conventional head clip;

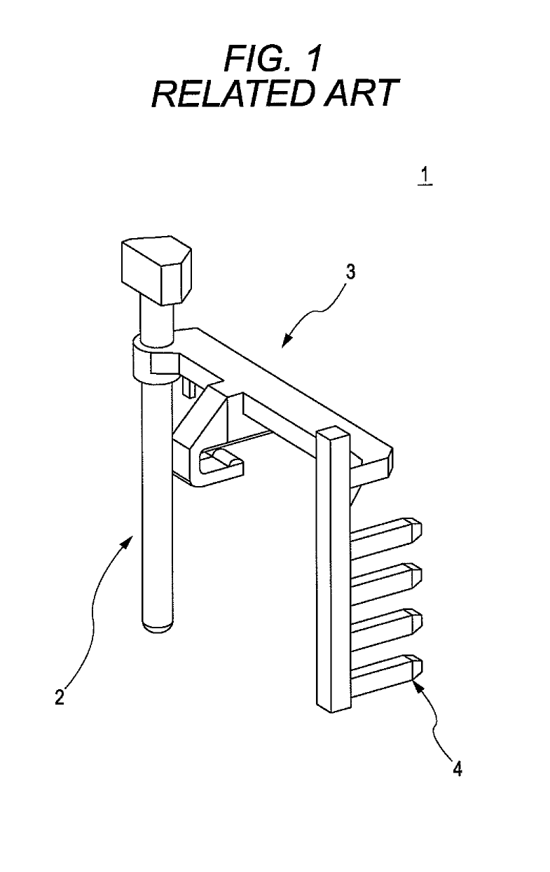

FIGS. 2A and 2B are views explaining how the head clip of FIG. 1 is attached to an actuator;

FIG. 3 is a view explaining how the head clip of FIG. 1 is attached to the actuator;

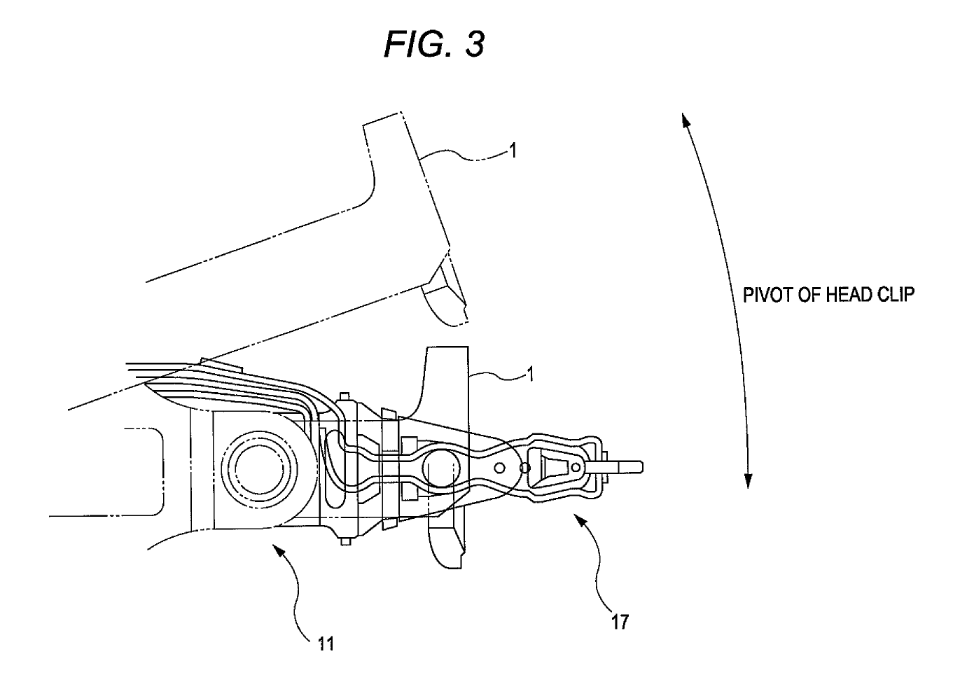

FIG. 4 is a view explaining how heads collide with each other due to shock and the like;

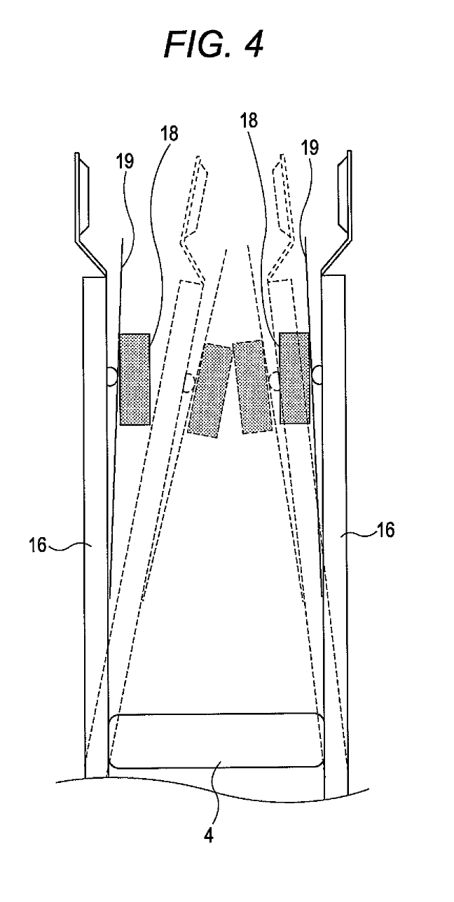

FIG. 5 is a view explaining how the heads collide with each other due to shock and the like;

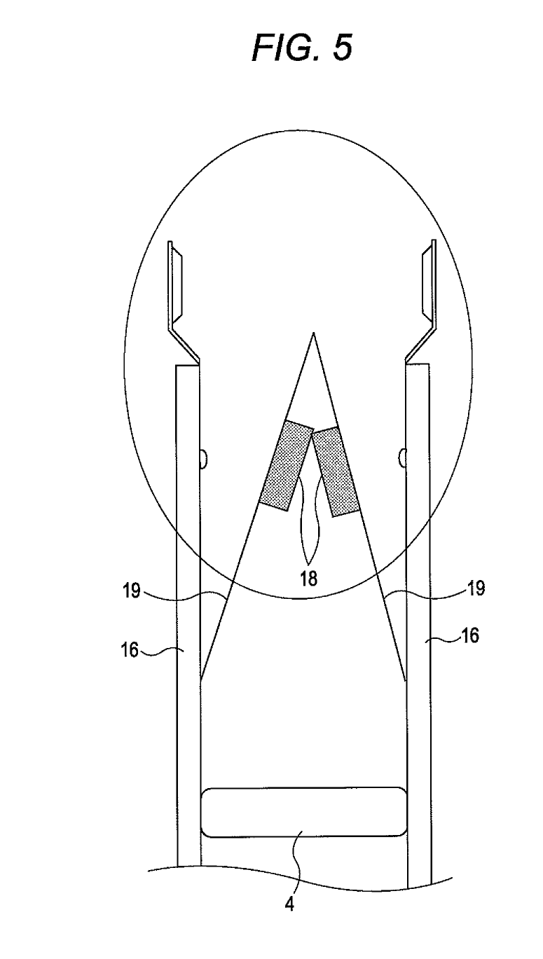

FIG. 6 is a plan view showing an example of a magnetic storage device having an actuator;

FIG. 7 is a perspective view showing an embodiment of a head clip of the present invention;

FIGS. 8A, 8B, and 8C are three surface views showing a side surface, a front surface, and an upper surface of the head clip shown in FIG. 7;

FIG. 9 is a perspective view showing a second support unit in enlargement;

FIGS. 10A, 10B, and 10C are three surface views showing a side surface, a front surface, and an upper surface of a support portion;

FIG. 11 is a view explaining how the head clip is attached to the actuator;

FIG. 12 is a plan view showing the head clip attached to the actuator;

FIG. 13 is a view showing the second support unit shown in FIG. 12 in enlargement; and

FIG. 14 is a front elevational view explaining how the head clip is attached to the actuator.

### DETAILED DESCRIPTION OF THE EMBODIMENTS

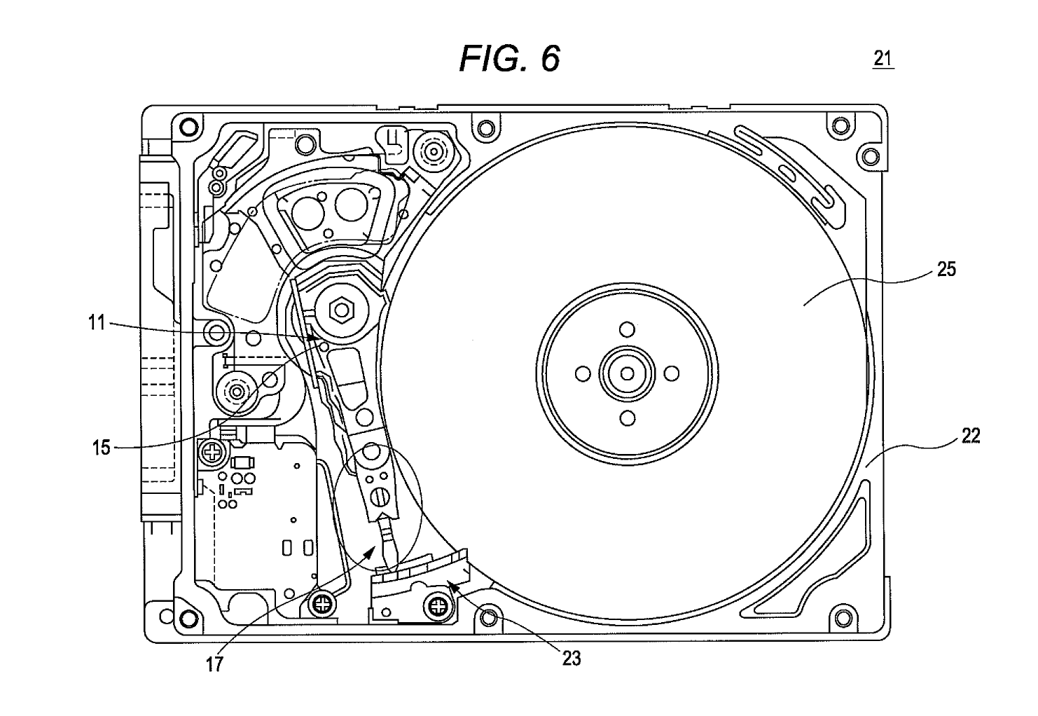

A head clip of an embodiment and respective embodiments of a working method using the head clip will be explained referring to FIG. 6 and subsequent views.

FIG. 6 is a plan view showing an example of a magnetic storage device having an actuator. In the example, the magnetic storage device is a magnetic disc device using a magnetic disc as a magnetic recording medium.

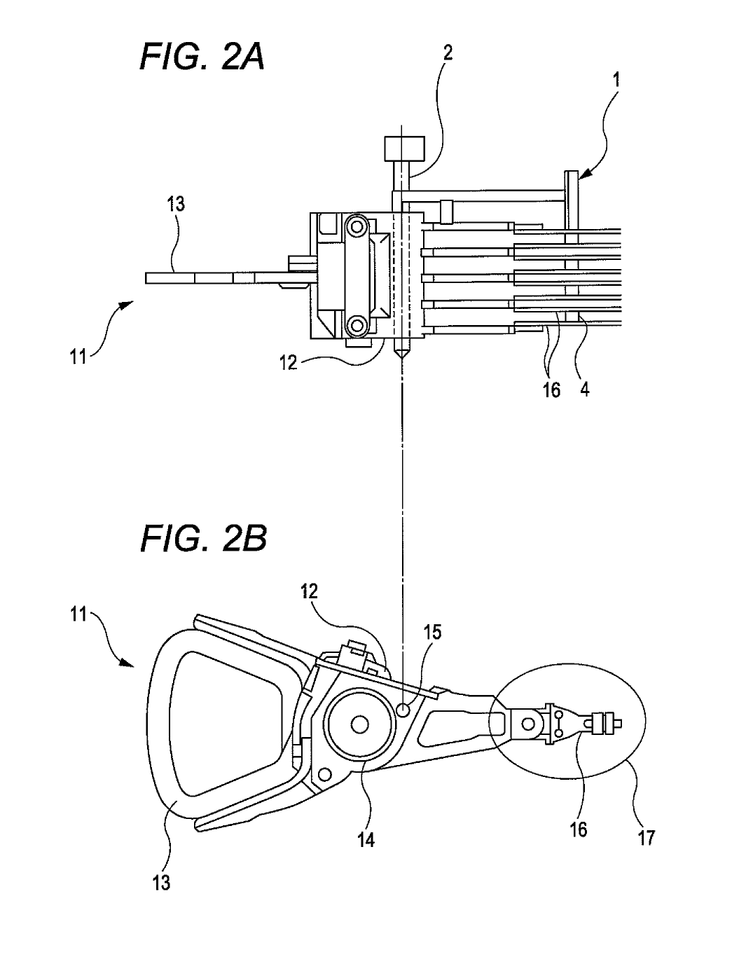

The magnetic disc device 21 shown in FIG. 6 has a known arrangement in which an actuator 11, a load/unload mechanism 23, a magnetic disc 25, and the like are disposed on a base 22. Since the actuator 11 has the arrangement explained referring to FIG. 2, the detailed explanation thereof is omitted. Heads 18, which are disposed at the extreme ends of suspensions 16 (that is, flexures 19) of the actuator 11, record a signal in the magnetic disc 25 rotated by a motor (not shown) and reproduce the signal recorded thereon. Note that the number of suspensions 16 and the number of heads 18 disposed on the actuator 11 are not particularly limited as long as the numbers are plural.

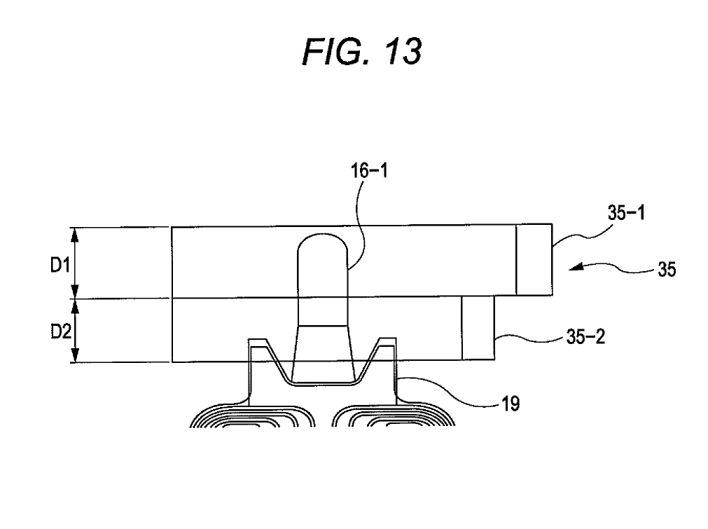

Since the actuator 11 is of a load/unload type for the convenience of explanation, the heads 18 are unloaded from the load/unload mechanism 23, move onto the magnetic disc 25 and are loaded on the load/unload mechanism 23 from on the magnetic disc 25 according to the operating mode of the magnetic disc device 21. As explained below referring to FIG. 13, a load/unload tab 16-1 is disposed at the extreme ends of the suspensions 16 of the actuator 11 so that the tab can be engaged with the load/unload mechanism 23. The load/unload tab 16-1 is formed integrally with, for example, the suspensions 16. Since the load/unload tab 16-1 is guided along the guide surface of the load/unload mechanism 23, the heads 18 are loaded on and unloaded from the load/unload mechanism 23. When the heads 18 are loaded on the load/unload mechanism 23, the heads 18 are evacuated to a position where the recording surface of the magnetic disc 25 is avoided.

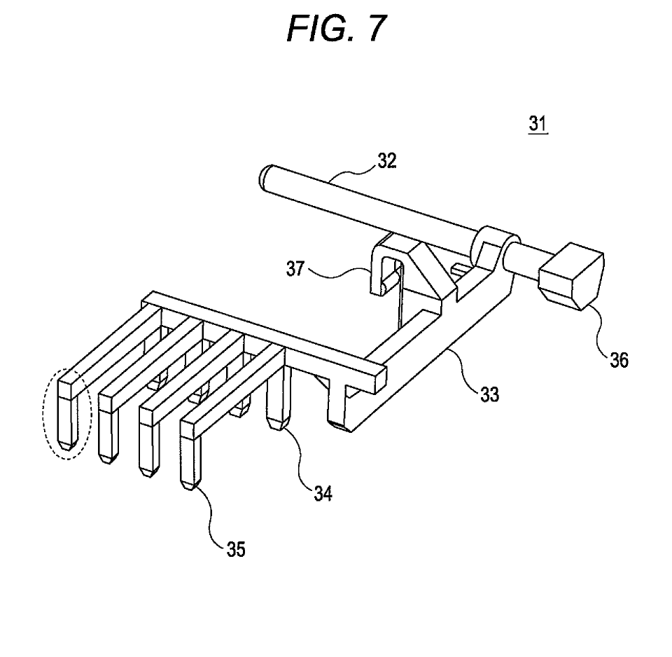

FIG. 7 is a perspective view showing an embodiment of the head clip of the present invention. The head clip 31 shown in FIG. 7 has a positioning shaft 32, a head fixing arm 33, a plurality of first support units 34, a plurality of second support units 35, a knob 36, and an engaging unit 37. The first support units 34 are comb-shaped teeth for supporting the suspensions 16, and the second support units 35 are comb-shaped teeth for supporting the load/unload tab 16-1.

Although a material used for the head clip 31 is not particularly limited, the head clip 31 is preferably formed of a material which is unlikely to cause static electricity. For example, the head clip 31 can be formed of a material having a resistance value of about 1×10¹² Ω·m or less. Further, the head clip 31 may be either formed integrally or formed by bonding a plurality of portions thereof. At least the portion of the head clip 31 which is in direct contact with the actuator 11 may be formed of material which is unlikely to cause static electricity.

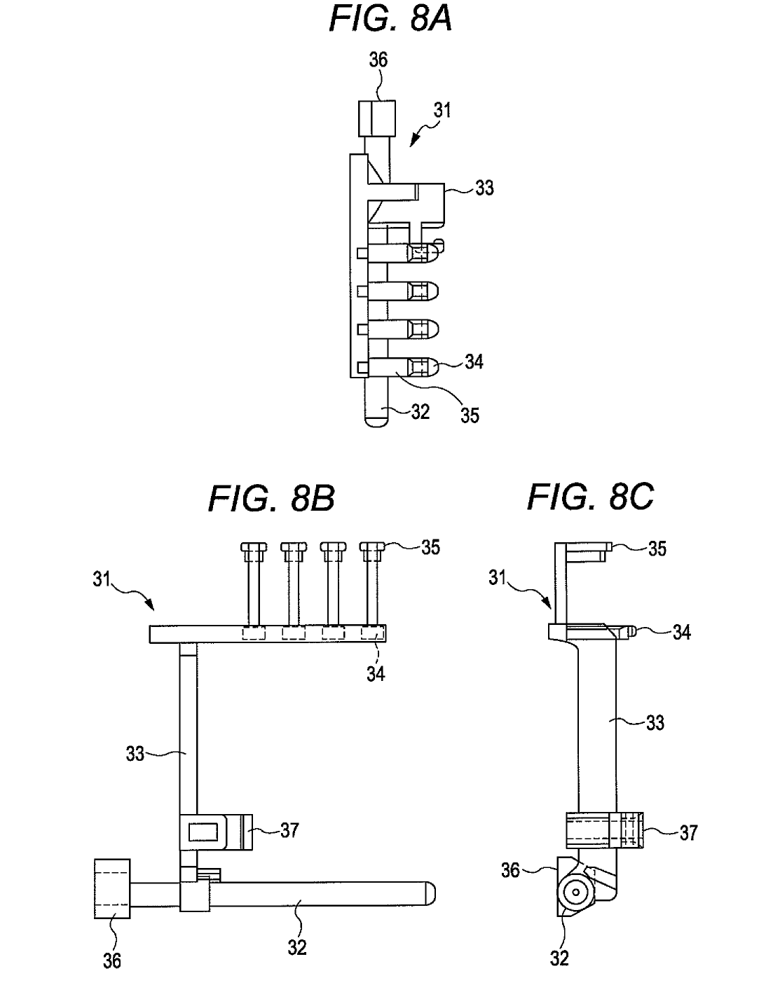

FIGS. 8A, 8B, and 8C are three surface views showing a side surface, a front surface, and an upper surface of the head clip shown in FIG. 7, wherein FIG. 8A is a side elevational view of the head clip 31, FIG. 8B is a front elevational view thereof, and FIG. 8C is an upper surface view thereof (that is, plan view).

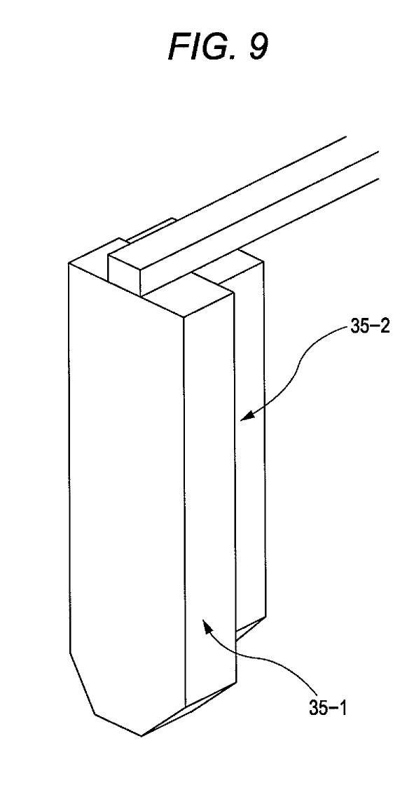

FIG. 9 is a perspective view showing a second support unit 35 surrounded by a broken line in FIG. 7 in enlargement. As shown in FIG. 91 the second support unit 35 has a first comb-shaped tooth 35-1 for supporting the load/unload tab 16-1 and a second comb-shaped tooth 35-2 for supporting flexures 19.

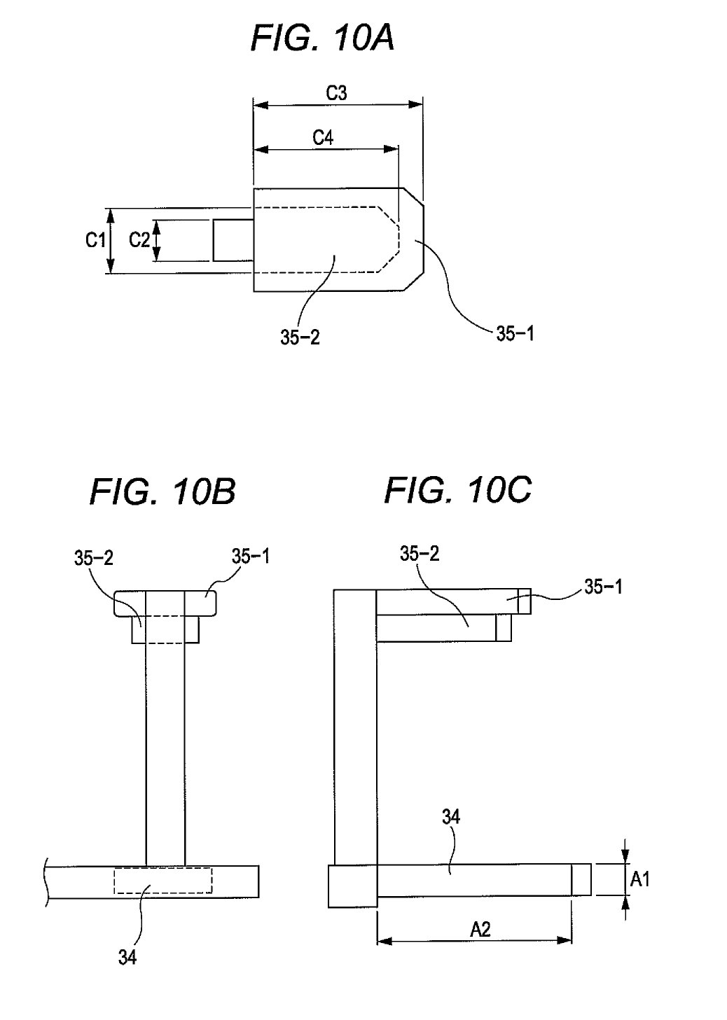

FIGS. 10A, 10B, and 10C are three surface views showing a side surface, a front surface, and an upper surface of the support portion including the first and second support units 34, 35, wherein FIG. 10A is a side elevational view of the support portion, FIG. 10B is a front elevational view thereof and FIG. 10C is an upper surface view thereof (that is, plan view).

As shown in FIGS. 10A to 10C, the extreme end of each of the first and second support units 34, 35, which is engaged with the actuator 11 first when the head clip 31 is attached to the actuator 11, has a taper shape. The taper shape is not particularly limited and may be formed of one or a plurality of slant surfaces or curved surfaces. The taper shape is formed so that when the head clip 31 is attached to the actuator 1 the first and second support units 34, 35 can be easily and securely inserted between two adjacent suspensions 16 and avoid collision between the first and second support units 34, 35 and the suspensions 16 and the like. Such a collision could possibly break the suspensions 16 and the like or at least apply a large shock and a large vibration to them.

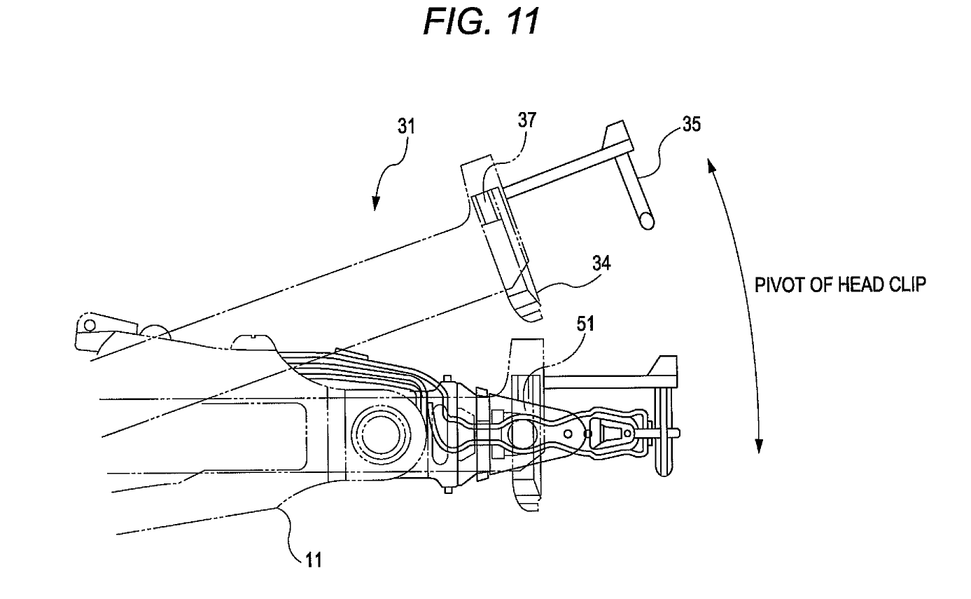

FIG. 11 is a view explaining how the head clip 31 is attached to the actuator 11. The head clip 31 is attached to the actuator 11 by inserting the shaft 32 (FIG. 7) into the hole 15 (see FIGS. 2A, 2B) from the upper surface side of the actuator 11 and pivoting the head clip 31 about the shaft 32 by pivoting the knob 36. When the head clip 31 is attached to the actuator 11, first, the first support units 34 are inserted between a pair of corresponding suspensions 16, and then the second support units 35 are inserted between the pair of corresponding suspensions 16. When the head clip 31 is attached to the actuator 11, the engaging unit 37 is engaged with a corresponding engaging portion 51 of the actuator 11, whereby the head clip 31 is tentatively fixed so that it is not easily removed from the actuator 11. The design of the engaging portion of the engaging unit 37 with the actuator 11 is not particularly limited as long as it has a shape by which it can be tentatively fixed, and a combination of, for example, a claw portion and a recessed portion, a convex portion and a recessed portion, and the like may be employed.

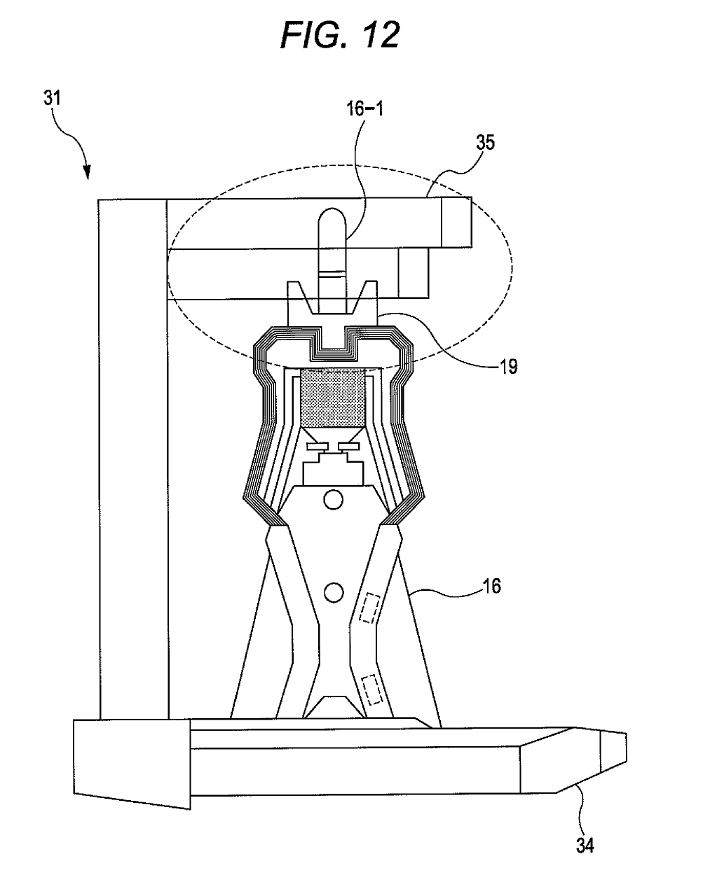

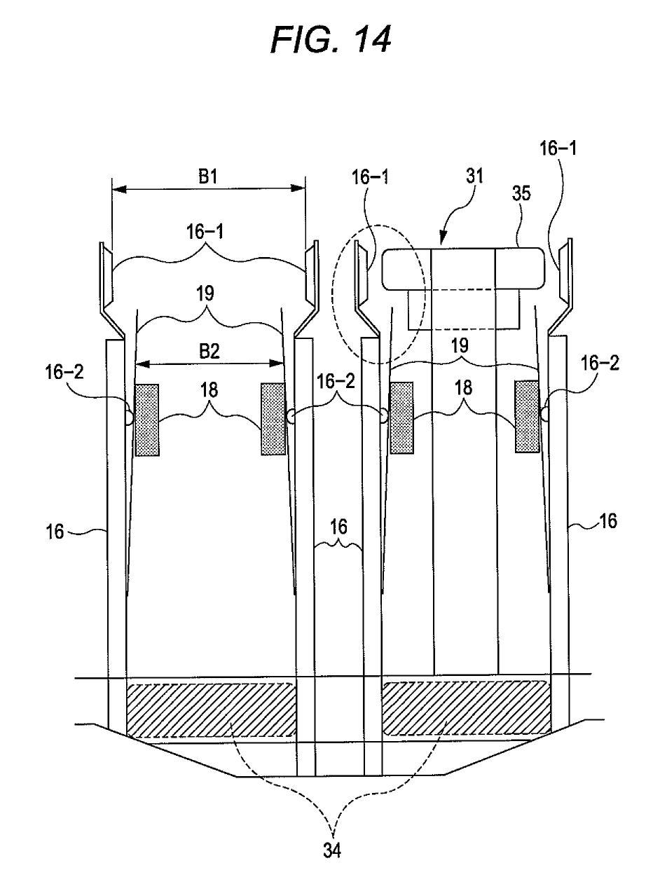

FIG. 11 is a bottom view of the actuator 11 showing how the head clip 31 is attached. FIG. 12 is a plan view showing the head clip 31 attached to the actuator 11, and FIG. 13 is a view showing the second support unit 35 surrounded by a broken line in FIG. 12 in enlargement. FIG. 14 is a front elevational view explaining how the head clip 31 is attached to the actuator 11. Note that, in FIG. 14, the second support unit 35 of the head clip 31 is not shown for the pair of the suspensions 16 on the left side and only the first support unit 34 is shown. Further, in FIG. 14, the flexure support portions 16-2 of the suspensions 16 support the flexures 19 so that the floating amounts of the heads 18 can be secured with respect to the magnetic discs 25. The flexure support portions 16-2 are integrally formed with, for example, the suspensions 16 in a hemispherical shape.

In the state that the head clip 31 is attached to the actuator 11, the first and second support portions 34, 35 are inserted between the two adjacent suspensions 16 as shown in FIG. 14 to prevent the heads 18, which are disposed on the outer ends of the suspensions 16, from colliding with each other in the head assembly 17. In this state, the suspensions 16 are supported by the first support units 34, and the first and second comb-shaped teeth 35-1, 35-2 of the second support units 35 are not in contact with the suspensions 16 (or flexures 19). When the suspensions 16 vibrate relatively largely, the first and second comb-shaped teeth 35-1, 35-2 come into contact with the suspensions 16 and regulate them to thereby prevent the suspensions 16 and the flexures 19 from vibrating in excess of an allowable range. In the embodiment, when the suspensions 16 vibrate, the load/unload tab 16-1 comes into contact with the first comb-shaped teeth 35-1 first, and when the suspensions 16 vibrate relatively largely, the flexures 19 come into contact with the second comb-shaped teeth 35-2 next, to thereby regulate the suspensions 16. With this operation, breakage of the heads 18 can be largely prevented. When the second comb-shaped teeth 35-2 are arranged to come into contact with the flexures 19 at the time the head clip 31 is attached to the actuator 11, there is a possibility that the flexures 19 may be broken. Accordingly, in the embodiment, an interval is formed between the extreme ends of the flexures 19 and the second comb-shaped teeth 35-2 of the second support units 35 when the head clip 31 is attached to the actuator 11.

Note that the suspensions 16 may be supported by the first support unit 34 and the first comb-shaped teeth 35-1 of the second support unit 35, and the second comb-shaped teeth 35-2 of the second support units 35 may not be in contact with the flexures 19 when the head clip 31 is attached to the actuator 11. In this case, the second comb-shaped teeth 35-2 come into contact with the flexures 19 when the flexures 19 vibrate relatively largely to thereby regulate the flexures 19 so that the flexures 19 are prevented from vibrating in excess of the allowable range.

Next, an example of the dimensions of the respective portions of the head clip 31 and the actuator 11 will be explained referring to FIGS. 10A to 10C and FIGS. 13 and 14.

In FIGS. 10A, 10B and 10C, A1 shows the maximum width of the first support unit 34 of the head clip 31 (an interval-widening amount of, that is, an interval between adjacent suspensions 16, which is most suitably set to each actuator 11), and A2 shows an effective range in which the width of the first support unit 34 of the head clip 31 is set to A1. Further, C1 shows a width of the first comb-shaped tooth 35-1 of the second support unit 35 of the head clip 31, and C2 shows a width of the second comb-shaped tooth 35-2 of the second support unit 35 of the head clip 31. Further, C3 shows a total length of the first comb-shaped tooth 35-1, and C4 shows a total length of the second comb-shaped tooth 35-2.

In FIG. 13, D1 shows the maximum width of the first comb-shaped tooth 35-1 of the second support unit 35 of the head clip 31, and D2 shows the maximum width of the second comb-shaped tooth 35-2 of the second support unit 35 of the head clip 31.

In FIG. 14, B1 shows an interval between the adjacent load/unload tabs 16-1 in the state that the head clip 31 is attached to the actuator 11 and the adjacent suspensions 16 are located adjacent with each other in the state that the intervals therebetween are widened by the first support units 34. Further, B2 shows the interval between adjacent flexures 19 in the state that the head clip 31 is attached to the actuator 11 and the intervals between the adjacent suspensions 16 are widened by the first support units 34.

When the head clip 31 is pivoted and attached to the actuator 11, the above dimensions can be set as follows. To insert the second support units 35 between the adjacent suspensions 16 after the first support units 34 are inserted therebetween, C3<A2 is established. Further, to insert the second comb-shaped teeth 35-2 between the flexures 19 of the adjacent suspensions 16 after the first comb-shaped teeth 35-1 of the second support units 35 are inserted therebetween, C4<C3 is established.

The above dimensions can be set as follows in the state that the head clip 31 is attached to the actuator 11. When the suspensions 16 are mainly supported by the first support units 34 of the head clip 31 and the second support units 35 supplementally support the suspensions 16 when they vibrate relatively largely, C1<B1 is established. Further, to prevent the second comb-shaped teeth 35-2 of the second support units 35 of the head clip 31 from being in contact with the flexures 19, C2<B2 is established.

The dimensions D1, D2 of the second support units 35 of the head clip 31 depend on the relation between the load/unload tabs 16-1 of the actuator 11 and the load/unload mechanism 23 of the magnetic disc device 21. That is, the dimensions D1, D2 can be set according to an amount of insertion and the like of the load/unload tabs 16-1 into the load/unload mechanism 23 in the state that the load/unload tabs 16-1 are loaded on the load/unload mechanism 23.

In the above embodiment, since the actuator 11 is of the load/unload type, the load/unload tabs 16-1 are effectively utilized so that the first comb-shaped teeth 35-1 of the second support units 35 of the head clip 31 support the extreme ends of the suspensions 16. However, the actuator to which the head clip 31 can be applied is not limited to the actuator of the load/unload type. When the head clip 31 is applied to an actuator of a type other than the load/unload type, it is sufficient for the first comb-shaped teeth 35-1 of the second support units 35 of the head clip 31 to support the extreme ends of the suspensions 16. That is, since the head clip 31 has such an arrangement that it supports adjacent suspensions at least two positions on the longitudinal direction of the actuator, it is sufficient for the two positions to be located across the heads and for one position to be located at the extreme end of the actuator.

Although the present invention has been described above with reference to the embodiment, it is needless to say that the present invention is not limited to the above embodiment and may be variously modified and improved within the range of the present invention.

What is claimed is:

1. A head clip attached to an actuator having heads at an extreme end thereof opposite to a pivoting fulcrum, comprising:
first and second support units inserted into the actuator so as to support suspensions to which the heads are disposed,
wherein the first support units are in contact with adjacent suspensions and support them at a first position which is located nearer to the pivoting fulcrum than to the heads in the longitudinal direction of the actuator,
the second support units regulate the adjacent suspensions at a second position located at the extreme end, and
the heads are disposed between the first position and the second position on the longitudinal direction.

2. The head clip according to claim 1, wherein the heads are disposed on flexures disposed on the suspensions, and the second support units regulate the flexures of the adjacent suspensions at the second position.

3. The head clip according to claim 1, further comprising:
a positioning shaft; and
a head fixing arm having a base portion coupled with the positioning shaft and an extreme end coupled with the first and second support units,
wherein the head clip is pivoted with respect to the actuator when the positioning shaft is inserted into a head clip insertion hole formed in the actuator so that the first and second support units are inserted between the adjacent suspensions.

4. The head clip according to claim 3, wherein the first and second support units have such shapes that when the head clip is pivoted with respect to the actuator, the first support units are inserted between the adjacent suspensions first and thereafter the second support units are inserted between the adjacent suspensions.

5. The head clip according to claim 3, wherein the respective portions of the first support units and the second support units which are inserted between the adjacent suspensions first when the head clip is pivoted with respect to the actuator have a taper shape.

6. The head clip according to claim 1, comprising a plurality of pairs of the first and second support units.
